(19) United States
(12) Patent Application Publication
(10) Pub. No.: US 2024/0388113 A1
(43) Pub. Date: Nov. 21, 2024

(54) CONSTANT CURRENT CHARGING DEVICE

(71) Applicant: SILICON INTEGRATED SYSTEMS CORP., Hsinchu City (TW)

(72) Inventors: Song Sheng LIN, Hsinchu City (TW); Keng-Nan CHEN, Hsinchu City (TW)

(73) Assignee: SILICON INTEGRATED SYSTEMS CORP., Hsinchu City (TW)

(21) Appl. No.: 18/664,966

(22) Filed: May 15, 2024

(30) Foreign Application Priority Data
May 18, 2023 (TW) 112118596

(51) Int. Cl. H02J 7/00

(52) U.S. Cl. CPC H02J 7/00712; H02J 7/0047

(57) ABSTRACT

A constant current charging device is configured to charge a device to be charged and includes: a reference current source configured to provide a reference current; a current mirror electrically coupled to the reference current source and configured to output a mirror current; a current adjustment control unit electrically coupled to the current mirror and the device to be charged wherein the current adjustment control unit is configured to output a charging current according to the mirror current to charge the device to be charged; and a current compensation unit electrically coupled to the current mirror and the current adjustment control unit. The current adjustment control unit includes a voltage follower unit, and the current adjustment control unit tracks a charging voltage through the voltage follower unit to stabilize the charging current.

### CROSS-REFERENCE TO RELATED APPLICATIONS

This application claims benefit of priority to Taiwan Patent Application No. 112118596 filed on May 18, 2023 in the Taiwan Intellectual Property Office, the disclosure of which is incorporated herein by reference in its entirety.

### FIELD OF INVENTION

The present invention relates to the field of charging technology, and in particular to a constant current charging device.

### BACKGROUND OF INVENTION

Conventional charging devices include two charging modes: a constant current charging mode and a constant voltage charging mode. The charging device charges the battery in constant current charging mode when the battery starts charging. The charging device switches to a constant voltage charging mode to charge the battery after the battery is charged to a certain voltage.

However, it is difficult to maintain stable output of current and voltage provided by conventional charging devices. Such unstable current and voltage output can easily lead to reduced charging efficiency and service life of the battery.

Therefore, it is necessary to propose a solution to the problems of the above-mentioned conventional technology.

### SUMMARY OF INVENTION

The purpose of the present invention is to properly solve the above-mentioned problems of the prior art without significantly increasing the design complexity or production cost.

Based on the above purpose, the present invention provides a constant current charging device for charging a device to be charged. The constant current charging device includes: a reference current source providing a reference current; a current mirror electrically coupled to the reference current source and outputting a mirror current; a current adjustment control unit electrically coupled to the current mirror and the device to be charged, wherein the current adjustment control unit outputs a charging current according to the mirror current to charge the device to be charged; and a current compensation unit electrically coupled to the current mirror and the current adjustment control unit, wherein the current adjustment control unit includes a voltage follower unit, and wherein the current adjustment control unit tracks a charging voltage through the voltage follower unit to stabilize the charging current.

The present invention has the following beneficial effects: the constant current charging device of the present invention can provide stable and controllable charging current through the current adjustment control unit and the current compensation unit. Furthermore, the constant current device of the present invention can design the charging current according to a channel width-to-length ratio of the transistor of the current mirror and the channel width-to-length ratio of the transistor of the current adjustment control unit. Finally, the constant current charging device of the present invention can provide stable charging current and charging voltage through the current adjustment control unit and the current compensation unit.

The purpose, technical content, characteristics and effects achieved by the present invention will be more easily understood through detailed descriptions of specific embodiments and accompanying figures.

### DESCRIPTION OF FIGURES

FIG. 1 shows a block diagram of a constant current charging device according to one embodiment of the present invention.

FIG. 2 shows a detailed circuit diagram of the constant current charging device of FIG. 1 of the present invention.

FIG. 3 shows a detailed circuit diagram of a voltage follower unit according to one embodiment of the present invention.

FIG. 4 shows a detailed circuit diagram of a voltage follower unit according to another embodiment of the present invention.

FIG. 5 shows a simulation diagram of a charging current I_{C} and a charging voltage V_{C} of FIG. 2 of the present invention.

FIG. 6 shows a voltage simulation diagram of the charging voltage V_{C}, a third contact p3, and a fourth contact p4 of FIG. 2 of the present invention, and a voltage simulation diagram of a second contact p2 when the voltage follower unit is in an inoperative state.

### DETAILED DESCRIPTION OF EMBODIMENTS

The present disclosure is particularly described with the following examples. These examples are only used for illustration, because for those skilled in the art, various modifications can be made without departing from the spirit and scope of the present invention. Therefore, a scope of protection of the present invention shall be determined by the appended claims. Referring to the figures, the same reference numerals represent the same elements.

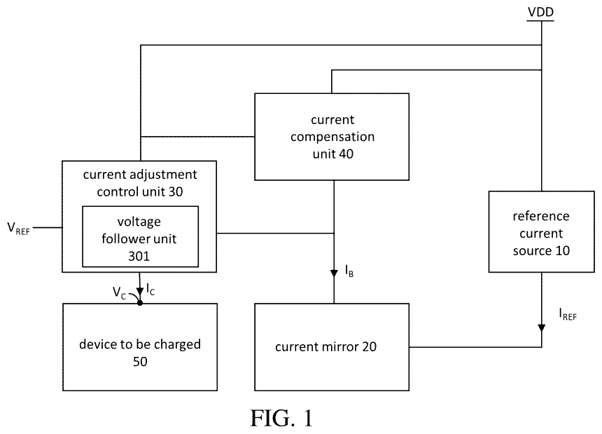

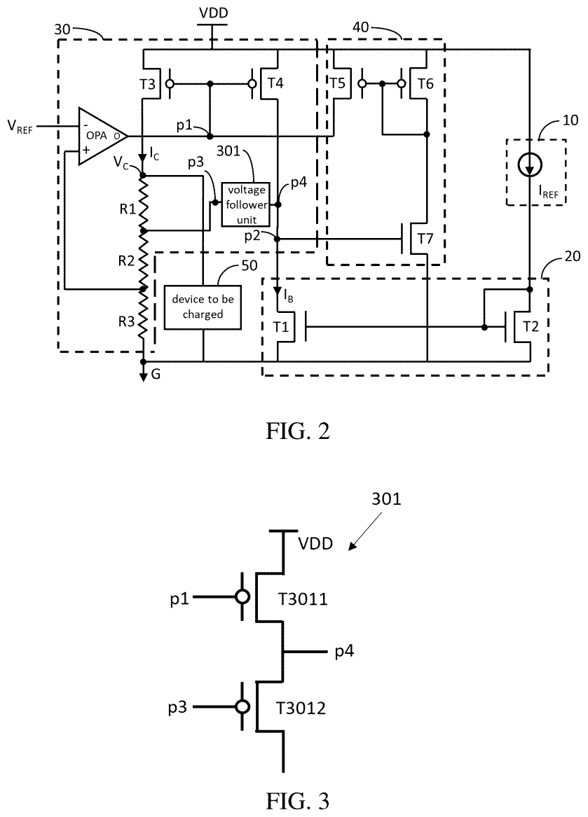

Please refer to FIG. 1 and FIG. 2, FIG. 1 shows a block diagram of a constant current charging device according to one embodiment of the present invention. FIG. 2 shows a detailed circuit diagram of the constant current charging device of FIG. 1 of the present invention.

The constant current device of the present invention is configured to charge the device to be charged 50 and includes a reference current source 10, a current mirror 20, a current adjustment control unit 30, and a current compensation unit 40.

The device to be charged 50 is a circuit or rechargeable battery that needs to be charged, or an electronic device including the aforementioned circuit or rechargeable battery that needs to be charged.

The reference current source 10 is electrically coupled to a power supply VDD and provides a reference current I_{REF}. The power supply VDD can be a DC power supply. The reference current I_{REF} can be adjusted according to needs.

The current mirror 20 is electrically coupled to the reference current source 10 and outputs a mirror current I_{B}, wherein the mirror current I_{B} may be M times the reference current I_{REF}.

The current adjustment control unit 30 is electrically coupled to the power supply VDD, the current mirror 20, and the device to be charged 50. The current adjustment control unit 30 outputs a charging current I_{C} according to the mirror current I_{B} to charge the device to be charged 50, wherein the charging current I_{C} may be N times the mirror current I_{B}. That is, the constant current charging device of the present invention outputs the charging current I_{C} through the current mirror 20 and the current adjustment control unit 30, and the output charging current I_{C} is M×N times the reference current I_{REF}. M, N, and M×N are all positive numbers. It should be noted that the current adjustment control unit 30 also includes a voltage follower unit 301. The current adjustment control unit 30 tracks the charging voltage and stabilizes the charging current I_{C} through the voltage follower unit 301.

The current compensation unit 40 is electrically coupled to the power supply VDD, the current mirror 20, and the current adjustment control unit 30. The current compensation unit 40 compensates the charging current I_{C} according to the reference voltage V_{REF}. In more detail, the constant current charging device of the present invention can be controlled by the current compensation unit 40 to increase or decrease the charging current I_{C}. Furthermore, the current compensation unit 40 may be designed to influence the voltage of the first contact p1. The reference voltage V_{REF} used to control the current compensation unit 40 can be adjusted according to needs.

It should be noted that, as shown in FIG. 1, an electrically coupled contact connected between the current adjustment control unit 30 and the current compensation unit 40 is different from an electrically coupled contact connected between the current adjustment control unit 30, the current mirror 20, and the current compensation unit 40. The constant current charging device in FIG. 1 of the present invention will be described in more detail below with reference to FIG. 2.

Referring to FIG. 2, the current mirror 20 includes a first transistor T1 and a second transistor T2. The first transistor T1 includes a first control terminal, a first input terminal, and a first output terminal. The second transistor T2 includes a second control terminal, a second input terminal, and a second output terminal.

The first control terminal is electrically coupled to the reference current source 10 and the second control terminal. The first input terminal is electrically coupled to the current adjustment control unit 30 and the current compensation unit 40. The first output terminal is electrically coupled to the ground terminal G. The second input terminal is electrically coupled to the reference current source 10. The second output terminal is electrically coupled to the ground terminal G.

In this embodiment, the first transistor T1 and the second transistor T2 may be N-type Metal-Oxide-Semiconductor Field-Effect Transistor (NMOSFET).

The current adjustment control unit 30 includes an operational amplifier OPA, a third transistor T3, a fourth transistor T4, a voltage follower unit 301, a first resistor R1, a second resistor R2, and a third resistor R3. The operational amplifier OPA includes an inverting input terminal −, a non-inverting input terminal +, and an output terminal O. The third transistor T3 includes a third control terminal, a third input terminal, and a third output terminal. The fourth transistor T4 includes a fourth control terminal, a fourth input terminal, and a fourth output terminal. The voltage follower unit 301 includes a voltage follower input terminal and a voltage follower output terminal.

The third output terminal is coupled to the device to be charged 50, and is coupled to the voltage follower input terminal through the first resistor R1. The inverting input terminal − is electrically coupled to the reference voltage V_{REF}. The non-inverting input terminal + is coupled to the voltage follower input terminal through the second resistor R2. The non-inverting input terminal + is coupled to the ground terminal G through the third resistor R3. The output terminal O is electrically coupled to the current compensation unit 40. The third control terminal is electrically coupled to the fourth control terminal and the current compensation unit 40. The third input terminal is electrically coupled to the power supply VDD. The fourth input terminal is electrically coupled to the power supply VDD. The fourth output terminal is electrically coupled to the voltage follower output terminal.

It should be noted that the first resistor R1, the second resistor R2, and the third resistor R3 can be an internal resistance and an external resistance of the operational amplifier OPA and the device to be charged 50, or can be resistors that facilitates the design of reference voltage V_{REF}, reference current I_{REF} and other related parameters of the constant current charging device. The illustrated positions of the first resistor R1, the second resistor R2, and the third resistor R3 disclosed in FIG. 2 are intended to represent the resistor values that can be changed by the designer. For example, the ratio of the charging voltage V_{C} to the reference voltage V_{REF} can be designed by designing the resistance values of the first resistor R1, the second resistor R2, and the third resistor R3, so that a maximum value of the charging voltage V_{C} is not limited by a maximum value of the reference voltage V_{REF}.

In this embodiment, the third transistor T3 and the fourth transistor T4 may be P-type Metal-Oxide-Semiconductor Field-Effect Transistor (PMOSFET).

The current compensation unit 40 includes a fifth transistor T5, a sixth transistor T6, and a seventh transistor T7. The fifth transistor T5 includes a fifth control terminal, a fifth input terminal, and a fifth output terminal. The sixth transistor T6 includes a sixth control terminal, a sixth input terminal, and a sixth output terminal. The seventh transistor T7 includes a seventh control terminal, a seventh input terminal, and a seventh output terminal.

The fifth control terminal is electrically coupled to the sixth control terminal, the sixth output terminal, and the seventh input terminal. The fifth input terminal is electrically coupled to the power supply VDD. The fifth output terminal is electrically coupled to the third control terminal. The sixth input terminal is electrically coupled to the power supply VDD. The seventh control terminal is coupled to the first input terminal. The seventh output terminal is electrically coupled to the ground terminal G.

In this embodiment, the fifth transistor T5 and the sixth transistor T6 may be PPMOSFETs, and the seventh transistor T7 may be an NMOSFET.

The operating principle of the constant current charging device of the present invention will be described in detail below.

First, the charging voltage V_{C} is zero in an initial state, a voltage of the non-inverting input terminal + (that is, equal to zero) is less than the reference voltage V_{REF}, and the output terminal O outputs a low voltage level. The third transistor T3 and the fourth transistor T4 are turned on, so that the seventh transistor T7 is turned on. The fifth transistor T5 and the sixth transistor T6 are turned on when the seventh transistor T7 is turned on. When the current flows through the fifth transistor T5, it will affect the voltage of the first contact p1 and the voltage of the second contact p2, thereby affecting the mirror current I_{B} and the charging current I_{C}.

In more detail, the mirror current I_{B} is related to a channel width-to-length ratio (W1/L1) of the first transistor T1 and a channel width-to-length ratio (W2/L2) of the second transistor T2. M is a ratio of the channel width-to-length ratio (W1/L1) of the first transistor T1 and the channel width-to-length ratio (W2/L2) of the second transistor T2. W1 is a channel width of the first transistor T1. L1 is a channel length of the first transistor T1. W2 is a channel width of the second transistor T2. L2 is a channel length of the second transistor T2. The relationship between the mirror current I_{B} and the reference current I_{REF} is as follows:

$${I}_{B} = M \times {I}_{R E F} = ( \frac{W 1}{L 1} / \frac{W 2}{L 2} ) \times {I}_{R E F}$$

The charging current I_{C} is related to a channel width-to-length ratio (W3/L3) of the third transistor T3 and a channel width-to-length ratio (W4/L4) of the fourth transistor T4. N is a ratio of the channel width-to-length ratio (W3/L3) of the third transistor T3 and the channel width-to-length ratio (W4/L4) of the fourth transistor T4. W3 is a channel width of the third transistor T3. L3 is a channel length of the third transistor T3. W4 is a channel width of the fourth transistor T4. L4 is a channel length of the fourth transistor T4. The relationship between charging current I_{C} and mirror current I_{B} is as follows:

$${I}_{C} = N \times {I}_{B} = N \times M \times {I}_{R E F} = ( \frac{W 3}{L 3} / \frac{W 4}{L 4} ) \times ( \frac{W 1}{L 1} / \frac{W 2}{L 2} ) \times {I}_{R E F}$$

From the above, it can be seen that the constant current charging device of the present invention can design the channel width to length ratio of the first transistor T1 (W1/L1), the channel width to length ratio of the second transistor T2 (W2/L2), the channel width to length ratio of the third transistor T3 (W3/L3), and the channel width-to-length ratio of the fourth transistor T4 (W4/L4) to provide a stable charging current I_{C}. Therefore, the charging current I_{C} can be designed with a high current value and controllable characteristics.

The output terminal O outputs a high voltage level when the charging voltage V_{C} rises and the receiving voltage of the non-inverting input terminal + approaches the reference voltage V_{REF}, thereby causing the current flowing through the third transistor and the fourth transistor to decrease. The mirror current I_{B} and the charging current I_{C} also decrease when the current flowing through the fourth transistor T4 decreases.

It should be noted that voltage follower unit 301 can be a voltage follower or as part of various configurations of voltage follower circuits, such as an electronic component coupling different types of voltage followers.

For example, please refer to FIG. 3, which shows a detailed circuit of the voltage follower unit 301 according to one embodiment of the present invention. In the embodiment disclosed in FIG. 3, the voltage follower unit 301 is composed of a first following transistor T3011 and a second following transistor T3012, wherein the control terminal of the first following transistor T3011 is connected to the first contact p1, and the control terminal of the second follower transistor T3012 (the voltage input terminal of the voltage follower unit 301) is connected to the third contact p3. An output terminal of the first following transistor T3011 and an input terminal of the second following transistor T3012 (the output terminal of the voltage follower unit 301) are coupled to a fourth contact p4. In the embodiment of FIG. 3, the first following transistor T3011 and the second following transistor T3012 may be PMOSFETS.

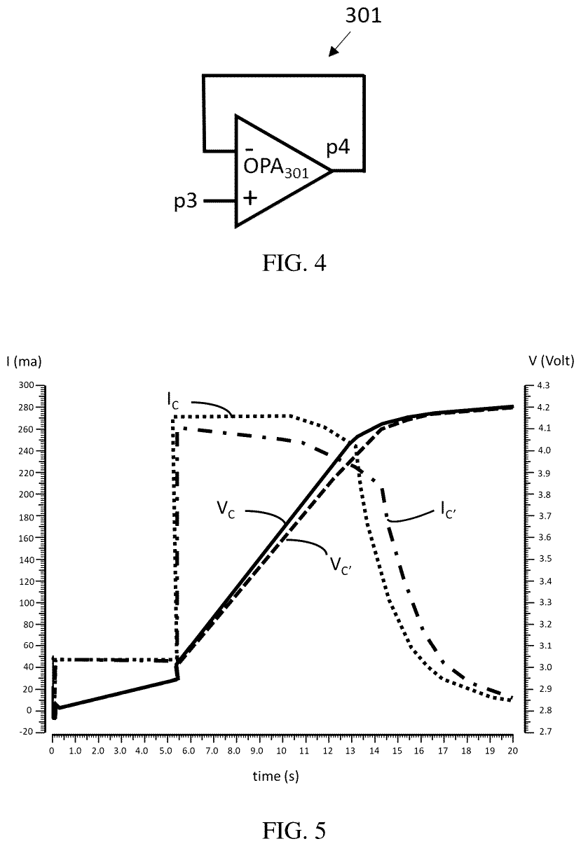

Please continue to refer to FIG. 4, which shows a detailed circuit of the voltage follower unit 301 according to another embodiment of the present invention. In the embodiment disclosed in FIG. 4, the voltage follower unit 301 is composed of a following operational amplifier OPA₃₀₁, wherein a non-inverting input terminal of the following operational amplifier OPA₃₀₁ (the input terminal of the voltage follower unit 301) is connected to the third contact p3, and an inverting input terminal of the following operational amplifier OPA₃₀₁ is connected to the output terminal of the following operational amplifier OPA₃₀₁ (the output terminal of the voltage follower unit 301), and the output terminal of the following operational amplifier OPA₃₀₁ is connected to the fourth contact p4.

It should be noted that the aforementioned FIG. 3 and FIG. 4 disclose only two examples of the voltage follower unit 301, and the voltage follower unit 301 to which the present invention is applicable is not limited thereto. The currently or future voltage follower that performs the voltage follower function can refer to the contact between the input terminal and the output terminal of the voltage follower unit 301 and is suitable for the constant current charging device provided by the present invention.

The voltage follower output terminal of the voltage follower unit 301 is connected to the fourth contact p4, and the voltage follower input terminal is connected between the first resistor R1 and the second resistor R2. Therefore, in a process of the charging voltage V_{C} rising, a decreasing curve of the current flowing through the fourth transistor T4 is affected by a potential of the fourth contact p4, thereby increasing the time during which the current flowing through the fourth transistor T4 is a high current, delaying a starting time of the drop of the current flowing through the fourth transistor T4, and accelerating the current decreasing speed of the fourth transistor T4. Therefore, the time during which the mirror current I_{B} and the charging current I_{C} output high current is extended by the voltage follower unit 301, and an efficiency of the constant current charging device in reducing the mirror current I_{B} and the charging current I_{C} is also improved. Therefore, the voltage follower unit 301 used to stabilize the output voltage exerts an effect of stabilizing the charging current I_{C} in the constant current charging circuit of the present invention.

The current adjustment control unit 30 reduces the charging current I_{C} when the charging voltage V_{C} rises and the receiving voltage of the non-inverting input terminal + approaches the reference voltage V_{REF}. The charging current I_{C} is zero when the received voltage at the non-inverting input terminal + is equal to the reference voltage V_{REF}.

In summary, the constant current charging device of the present invention can provide stable charging current I_{C} and charging voltage V_{C} through the current adjustment control unit 30 and the current compensation unit 40. Furthermore, the constant current charging device of the present invention can provide a controllable charging current I_{C} with a high current value through the current mirror 20 and the current adjustment control unit 30. In addition, the constant current charging device of the present invention can extend the time during which the mirror current I_{B} and the charging current I_{C} output high current and the time during which the charging voltage V_{C} outputs high voltage through the current adjustment control unit 30, thereby improving an efficiency that the constant current charging device reducing the mirror current I_{B}, an efficiency that the constant current charging device reducing the charging current I_{C}, and an efficiency that the constant current charging device increasing the charging voltage V_{C}.

Please refer to FIG. 5, which shows a simulation diagram of the charging current I_{C} and the charging voltage V_{C} in FIG. 2.

In the simulation diagram of FIG. 5, under one of implementation conditions: the power supply VDD is 5 volts, the reference voltage V_{REF} is 1.2 volts, the reference current I_{REF} is 120 microamps, the charging current is 280 milliamperes, and the device to be charged 50 has 1 farad capacitor. In addition to illustrating the simulation diagram of the charging current I_{C} and the charging voltage V_{C} of the circuit of FIG. 2 under the aforementioned conditions, FIG. 5 also illustrates a simulation diagram of charging current I_{C} and charging voltage V_{C} of the circuit of FIG. 2 when the voltage follower unit 301 is cancelled. In detail, the fourth output terminal is directly connected to the first input terminal after canceling the voltage follower unit 301, and the simulation diagram of the charging current I_{C} and the charging voltage V_{C} is a simulation diagram of the charging current and charging voltage of this circuit architecture.

As can be seen from FIG. 5, the charging current I_{C}, I_{C′} can quickly provide stable current (280 mA), (260 mA). The charging current I_{C}, I_{C′} decreasing gradually when the charging voltage V_{C}, V_{C′} gradually rises. The charging current I_{C}, I_{C′} drops rapidly to 0 mA when the charging voltage V_{C}, V_{C′} rises to 4.2 volts.

Further, as shown in FIG. 5, compare the charging current I_{C} when the voltage follower unit 301 is operating and the charging current I_{C′} when the voltage follower unit 301 is cancelled. When the constant current device starts to output current, the charging current I_{C} can output a more stable current than the charging current I_{C′}, and the charging voltage V_{C} rises faster than the charging voltage V_{C′}. That is, the constant current charging circuit disclosed in FIG. 2 of the present invention uses the current adjustment control unit 30 to combine the current mirror 20, the current compensation unit 40, and the voltage follower unit 301 to provide charging current I_{C} with a smoother high current output and a faster dropping efficiency, and a charging voltage V_{C} with a smoother high voltage output and faster rising efficiency.

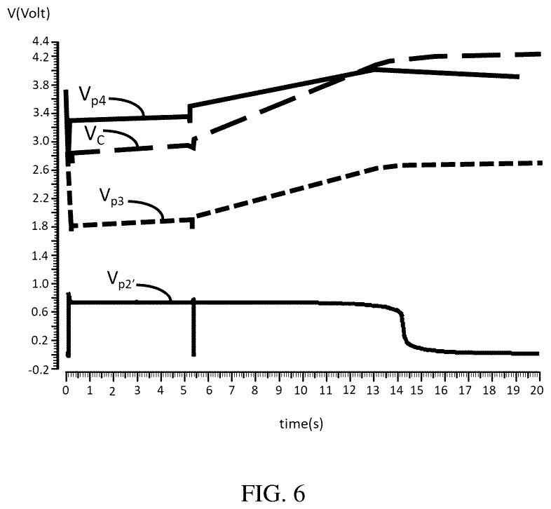

Please refer to FIG. 6, FIG. 6 shows a voltage simulation diagram of the charging voltage V_{C}, the third contact p3, and the fourth contact p4 in FIG. 2 of the present invention, and a voltage simulation diagram of the second contact p2′ when the voltage follower unit in the circuit of FIG. 2 is in an inoperative state. Specifically, when the voltage follower unit 301 in FIG. 2 is cancelled, the second contact p2′ is a contact between the fourth output terminal and the first input terminal, and connecting the current compensation unit 40.

As can be seen from FIG. 6, the voltages of the third contact p3, the fourth contact p4, and the charging voltage V_{C} rise synchronously. Even when the rising curve of the charging voltage V_{C} starts to flatten, the voltages at the third contact p3, the fourth contact p4 do not drop significantly. In contrast, the voltage of the second contact p2′ drops sharply around the 14th second when the voltage follower unit 301 is cancelled.

The constant current charging device of the present invention can provide a stable and controllable charging current through the current adjustment control unit and the current compensation unit (as shown in FIG. 5). Furthermore, the constant current charging device of the present invention can design the charging current according to the channel width-to-length ratio of the transistor of the current mirror and the channel width-to-length ratio of the transistor of the current adjustment control unit. Finally, the constant current charging device of the present invention can provide stable charging current and charging voltage through the current adjustment control unit and the current compensation unit (as shown in FIG. 5 and FIG. 6), thereby improving the efficiency and service life of charging performance of the connected device to be charged.

It should be noted that the combination of various elements in the present invention preferably forms the above-mentioned embodiments, but this should not be construed as a limitation of the present invention. That is, there can be more combinations of various elements in the present invention, and it is not limited to various embodiments described above.

This specification uses specific examples to illustrate the principles and implementations of the present invention. The description of the above embodiments is only used to help understand the technical solutions and core ideas of the present invention. Those of ordinary skill in the art should understand that they can still modify the technical solutions recorded in the foregoing embodiments, or make equivalent substitutions for some of the technical features. However, these modifications or substitutions do not cause the essence of the corresponding technical solution to depart from a scope of the technical solution of each embodiment of the present invention.

What is claimed is:

1. A constant current charging device configured to charge a device to be charged, the constant current charging device comprises:
a reference current source providing a reference current;
a current mirror electrically coupled to the reference current source and outputting a mirror current;
a current adjustment control unit electrically coupled to the current mirror and the device to be charged, the current adjustment control unit outputs a charging current according to the mirror current to charge the device to be charged; and
a current compensation unit electrically coupled to the current mirror and the current adjustment control unit,
wherein the current adjustment control unit comprises a voltage follower unit, and wherein the current adjustment control unit tracks a charging voltage through the voltage follower unit to stabilize the charging current.

2. The constant current charging device according to claim 1, wherein the mirror current is M times the reference current, and M is a positive number, and wherein the charging current is N times the mirror current, and N is a positive number.

3. The constant current charging device according to claim 1, wherein the current adjustment control unit comprises a first contact electrically coupled to the current compensation unit and a second contact electrically coupled to the current compensation unit and the current mirror, and wherein the current adjustment control unit receives an output voltage of the current compensation unit through the first contact, and receives the mirror current and the tracked charging voltage through the second contact.

4. The constant current charging device according to claim 2, wherein the current mirror comprises:
a first transistor comprising a first control terminal, a first input terminal, and a first output terminal; and
a second transistor comprising a second control terminal, a second input terminal, and a second output terminal,
wherein the first control terminal is electrically coupled to the reference current source and the second control terminal, wherein the first input terminal is electrically coupled to the current adjustment control unit and the current compensation unit, wherein the first output terminal is electrically coupled to a ground terminal, wherein second input terminal is electrically connected to the reference current source, and wherein the second output terminal is electrically coupled to the ground terminal.

5. The constant current charging device according to claim 4, wherein the current adjustment control unit comprises:
an operational amplifier comprising an inverting input terminal, a non-inverting input terminal, and an output terminal;
a third transistor comprising a third control terminal, a third input terminal, and a third output terminal;
a fourth transistor comprising a fourth control terminal, a fourth input terminal, and a fourth output terminal; and
the voltage follower unit comprising a voltage follower input terminal and a voltage follower output terminal,
wherein the third output terminal is coupled to the device to be charged, and is coupled to the voltage follower input terminal through a first resistor, wherein the inverting input terminal is electrically coupled to a reference voltage, wherein the non-inverting input terminal is electrically coupled to the voltage follower input terminal through a second resistor, wherein the non-inverting input terminal is coupled to the ground terminal through a third resistor, wherein the output terminal is electrically coupled to the current compensation unit, wherein the third control terminal is electrically coupled to fourth control terminal and the current compensation unit, wherein the third input terminal is electrically coupled to a power supply, wherein the fourth input terminal is electrically coupled to the power supply, and wherein the fourth output terminal is electrically coupled to the voltage follower output terminal.

6. The constant current charging device according to claim 5, wherein the current compensation unit comprises:
a fifth transistor comprising a fifth control terminal, a fifth input terminal, and a fifth output terminal;
a sixth transistor comprising a sixth control terminal, a sixth input terminal, and a sixth output terminal; and
a seventh transistor comprising a seventh control terminal, a seventh input terminal, and a seventh output terminal,
wherein the fifth control terminal is electrically coupled to the sixth control terminal, the sixth output terminal, and the seventh input terminal, wherein the fifth input terminal is electrically coupled to the power supply, wherein the fifth output terminal is electrically coupled to the third control terminal, wherein the sixth input terminal is electrically coupled to the power supply, wherein the seventh control terminal is coupled to the first input terminal, and wherein the seventh output terminal is electrically coupled to the ground terminal.

7. The constant current charging device according to claim 4, wherein M is a ratio of a channel width-to-length ratio of the first transistor and a channel width-to-length ratio of the second transistor.

8. The constant current charging device according to claim 5, wherein N is a ratio of a channel width-to-length ratio of the third transistor and a channel width-to-length ratio of the fourth transistor.

9. The constant current charging device according to claim 5, wherein the current compensation unit is further configured to adjust a voltage input to the third control terminal and the fourth control terminal.

10. The constant current charging device according to claim 9, wherein the charging current is zero when the input voltage of the non-inverting input terminal is equal to the reference voltage.
